(19) United States
(12) Patent Application Publication
(10) Pub. No.: US 2026/0210306 A1
(43) Pub. Date: Jul. 23, 2026

(54) ALTERNATOR CONTROLS FOR QUICK ENGINE TORQUE MODULATION

(71) Applicant: FCA US LLC, Auburn Hills, MI (US)

(72) Inventors: Basil M Khaja, Auburn Hills, MI (US); James J Daley, Auburn Hills, MI (US); Drushan Mavalankar, Auburn Hills, MI (US); Leo Bauer, Auburn Hills, MI (US)

(21) Appl. No.: 19/034,796

(22) Filed: Jan. 23, 2025

(51) Int. Cl. F02D 29/06; B60W 10/06; B60W 10/10; B60W 10/26; F02D 29/02

(52) U.S. Cl. CPC F02D 29/06; B60W 10/06; B60W 10/10; B60W 10/26; F02D 29/02

(57) ABSTRACT

An engine torque control system and method for a vehicle include an alternator driven by a crankshaft of an engine of the vehicle and configured to generate electrical energy, an energy storage system configured to receive at least a maximum current from the alternator while the alternator is operating at a maximum duty cycle, and a control system configured to detect a request to decrease a torque generated by the engine by a desired torque reduction and, in response to detecting the request, command the alternator to operate at a desired duty cycle based on the desired torque reduction, wherein the energy storage system receives and stores the electrical energy generated by the alternator while operating at the desired duty cycle.

### FIELD

The present application generally relates to engine torque control and, more particularly, to techniques for controlling a vehicle alternator for quick engine torque modulation.

### BACKGROUND

An internal combustion engine combines air and fuel (gasoline, diesel, etc.) within cylinders and compresses the air/fuel mixture using pistons. The compressed air/fuel mixture is ignited by spark, which drives the pistons and generates drive torque at a crankshaft. The drive torque at the crankshaft is typically transferred to a driveline of the vehicle via a transmission (e.g., a multi-speed automatic transmission). Engine torque reduction can be requested for various reasons, such as a transmission shift operation (e.g., an upshift to a higher gear). Conventional methods for reducing engine torque include spark retardation and reducing airflow. Spark retardation is preferred for quick engine torque reduction as spark control is a fast-path torque actuator and airflow control is a slow-path torque actuator. Spark retardation, however, also decreases engine efficiency as the spark does not occur at an optimal timing. Accordingly, while such conventional engine torque control systems do work for their intended purpose, there exists an opportunity for improvement in the relevant art.

### SUMMARY

According to one example aspect of the invention, an engine torque control system for a vehicle is presented. In one exemplary implementation, the engine torque control system comprises an alternator driven by a crankshaft of an engine of the vehicle and configured to generate electrical energy, an energy storage system configured to receive at least a maximum current from the alternator while the alternator is operating at a maximum duty cycle, and a control system configured to detect a request to decrease a torque generated by the engine by a desired torque reduction and, in response to detecting the request, command the alternator to operate at a desired duty cycle based on the desired torque reduction, wherein the energy storage system receives and stores the electrical energy generated by the alternator while operating at the desired duty cycle.

In some implementations, the request corresponds to a shift request for a transmission arranged between the crankshaft of the engine and a driveline of the vehicle. In some implementations, the shift request is for an upshift of the transmission. In some implementations, the energy storage system is not a lead-acid or absorbent glass mat (AGM) battery. In some implementations, the energy storage system is a lithium-ion battery. In some implementations, the energy storage system includes at least one of the lithium-ion battery and at least one of a supercapacitor and an ultracapacitor. In some implementations, the request corresponds to a request to replace or supplement spark retardation for catalyst light-off. In some implementations, the request corresponds to a request to stabilize an idle speed of the engine. In some implementations, the alternator is not a belt-driven starter-generator (BSG) unit having an electric motor. In some implementations, the maximum current from the alternator while the alternator is operating at the maximum duty cycle is greater than 150 A.

According to another example aspect of the invention, an engine torque control method for a vehicle is presented. In one exemplary implementation, the engine torque control method comprises providing an alternator driven by a crankshaft of an engine of the vehicle and configured to generate electrical energy, providing an energy storage system configured to receive at least a maximum current from the alternator while the alternator is operating at a maximum duty cycle, detecting, by a control system of the vehicle, a request to decrease a torque generated by the engine by a desired torque reduction, and in response to detecting the request, commanding, by the control system, the alternator to operate at a desired duty cycle based on the desired torque reduction, wherein the energy storage system receives and stores the electrical energy generated by the alternator while operating at the desired duty cycle.

In some implementations, the request corresponds to a shift request for a transmission arranged between the crankshaft of the engine and a driveline of the vehicle. In some implementations, the shift request is for an upshift of the transmission. In some implementations, the energy storage system is not a lead-acid or AGM battery. In some implementations, the energy storage system is a lithium-ion battery. In some implementations, the energy storage system includes at least one of the lithium-ion battery and at least one of a supercapacitor and an ultracapacitor. In some implementations, the request corresponds to a request to replace or supplement spark retardation for catalyst light-off. In some implementations, the request corresponds to a request to stabilize an idle speed of the engine. In some implementations, the alternator is not a BSG unit having an electric motor. In some implementations, the maximum current from the alternator while the alternator is operating at the maximum duty cycle is greater than 150 A.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a vehicle having an alternator and an example engine torque control system according to the principles of the present application;

FIGS. 2A-2B are plots of example engine speed and torque reduction during a transmission upshift operation according to the principles of the present application; and

FIG. 3 is a flow diagram of an example engine torque control method for a vehicle having an alternator according to the principles of the present application.

### DESCRIPTION

As previously discussed, engine torque reduction can be requested for various reasons, such as a transmission shift operation (e.g., an upshift to a higher gear). Spark retardation is preferred conventional method for quick engine torque reduction as spark control is a fast-path torque actuator. Spark retardation, however, also decreases engine efficiency as the spark does not occur at an optimal timing. Many vehicles include an alternator driven (e.g., by a serpentine belt) by a crankshaft of the engine and configured to generate electrical energy (current) for powering accessory loads and/or recharging a low voltage (e.g., 12V) battery. Conventional 12V vehicle batteries typically include lead-acid or absorbent glass mat (AGM) type batteries, which are capable of receiving ~30-50 A of current. Conventional alternators, however, are capable of generating at least 150 A of current, and up to 360-400 A of current for heavy duty alternators (e.g., for heavy duty truck applications). Accordingly, improved alternator controls for quick engine torque modulation are presented herein.

The proposed systems and methods require that the vehicle have an energy storage system capable of handling these larger currents that can be generated by conventional alternators. Examples of such energy storage systems include lithium-ion (Li-ion) batteries and super/ultracapacitors, or some combination thereof, which is capable of receiving upwards of 400 A of current. Provided that the energy storage system is capable of receiving current (e.g., based on its state of charge, or SOC, relative to a maximum SOC threshold), the alternator can be activated (at a desired duty cycle) to quickly reduce engine torque for a short period. Potential benefits include fast torque reduction without additional hardware or the reduced engine efficiency associated with engine spark retardation.

While engine shift operations are specifically described herein, it will be appreciated that the torque control techniques of the present application could be used for other applications, such as, but not limited to, engine idle speed control (e.g., helping stabilize engine speed at idle by either counter-acting speed spikes/dips or by adding a constant load) and replacing parts of spark retardation for catalyst light-off (e.g., when an exhaust catalyst is cold, alternator load could be added to allow more fuel to be burned and thus more hot exhaust gas could be generated and passed through the catalyst to quickly heat it up).

It will be appreciated that the term “alternator” as used herein also refers to a conventional vehicle alternator system and not to a more expensive/more complex MGU or similar electric motor system. The specific type of alternator must also be able to be controlled to a set or specified duty cycle or output by a control system and not internally by the alternator itself. Self-controlled alternators, in contrast, control their own duty cycles or output based on electrical demand load changes (lights, pumps, heating/ventilation/air conditioning, or HVAC, etc.).

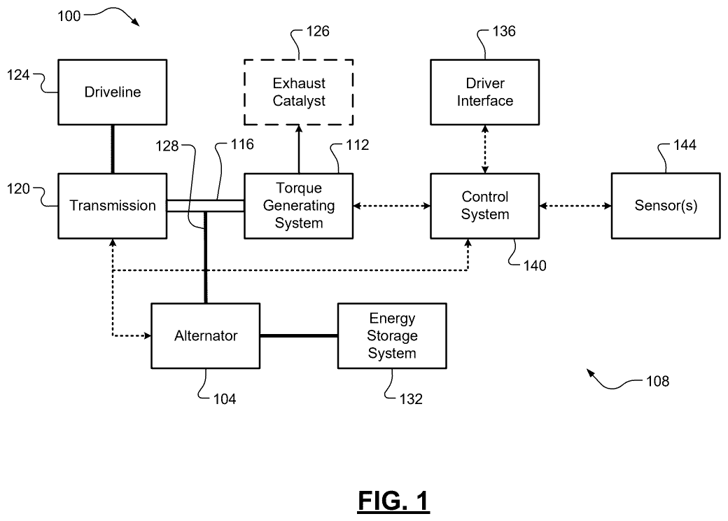

Referring now to FIG. 1, a functional block diagram of a vehicle 100 having an alternator 104 and an example engine torque control system 108 according to the principles of the present application is illustrated. The vehicle 100 comprises a torque generating system 112 configured to generate drive torque at an output shaft 116. In one exemplary implementation, the torque generating system 112 includes an internal combustion engine configured to combust a mixture of air and fuel (gasoline, diesel, etc.) to generate drive torque at a crankshaft. It will be appreciated that the torque generating system 112 could alternatively or additionally include one or more electric motors (electric traction motors, a motor-generator unit or MGU, etc.). The drive torque at the output shaft is transferred via a transmission 120 (e.g., a multi-speed step-gear automatic transmission) to a driveline 124 for vehicle propulsion. For an engine-based configuration of the torque generating system, exhaust gas resulting from combustion of the air/fuel mixture can be treated by an exhaust system including a catalyst 126 (e.g., a three-way catalytic converter) to mitigate or eliminate emissions (e.g., once the catalyst 126 reaches a light-off temperature).

The alternator 104 is driven by the output shaft 116 of the torque generating system 112 via a pulley and serpentine belt system or another suitable drive system 128. The driving of the alternator 104 causes the alternator 104 to generate electrical energy (current) that is used to recharge an energy storage system (ESS) 132. The ESS 132 is a device/system that is capable of receiving high levels of charging current (e.g., 400 A or more). Examples of the ESS 132 include a low voltage (e.g., 12V) Li-ion battery system and/or super/ultracapacitor, but not conventional lead-acid or AGM type batteries. The torque generating system 112 is primarily controlled to generate a sufficient amount of drive torque to satisfy a torque request provided by a driver of the vehicle 100 via a driver interface 136 (e.g., an accelerator pedal).

A controller or control system 140 is configured to control the operation of the various components of the vehicle 100, including the torque generating system 112, the transmission 120 (e.g., upshift and downshift operations), and the alternator 104 (e.g., a duty cycle). This control can be based, for example, on measured operating parameters of the vehicle 100 provided by a set of one or more sensors 144.

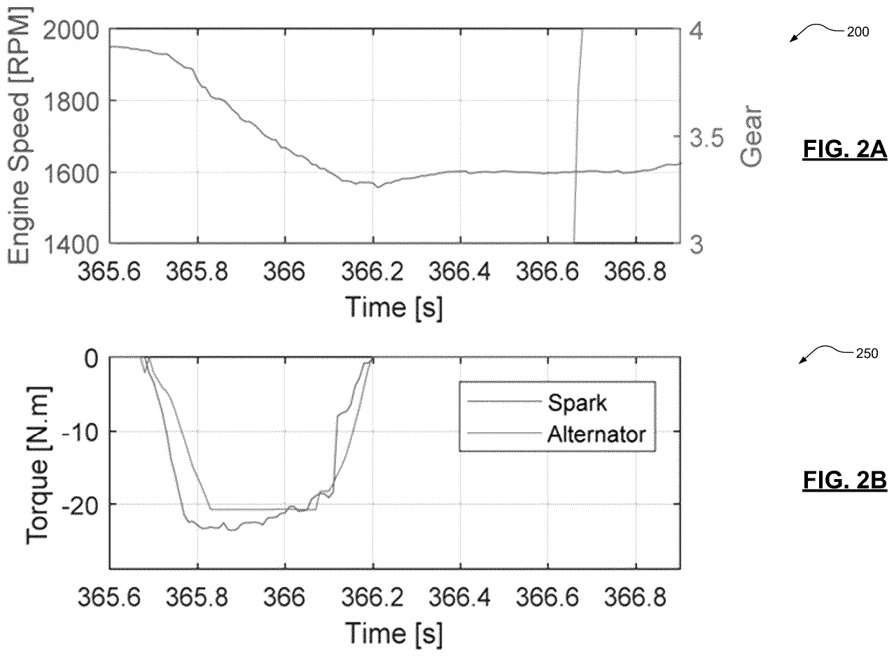

Referring now to FIGS. 2A-2B and with continued reference to FIG. 1, plots 200 and 250 of example engine speed and torque reduction during a transmission upshift operation according to the principles of the present application are illustrated. As shown in plot 200 of FIG. 2A, engine speed (in revolutions per minute, or RPM) is reduced over a short period of time (less than one second) from approximately 1950 RPM to approximately 1600 RPM. This engine speed reduction corresponds to a torque reduction in anticipation of an upshift operation (from 3^{rd} gear to 4^{th} gear) of the transmission 120.

As shown in corresponding plot 250 of FIG. 2B, spark retardation and the alternator control of the present application are both capable of achieving the same desired torque reduction of approximately 20 Newton-meters (Nm) of engine torque to achieve the engine speed reduction and upshift operation of FIG. 2A. The benefit of the alternator control of the present application, however, is there is no reduction in engine efficiency due to spark retardation.

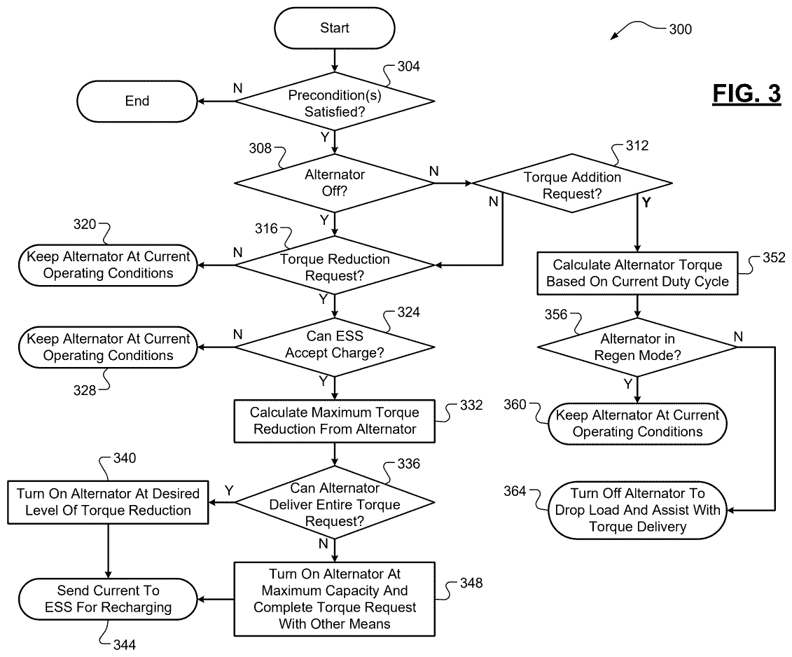

Referring now to FIG. 3 and with continued reference to the previous figures, a flow diagram of an example engine torque control method 300 for a vehicle having an alternator according to the principles of the present application is illustrated. While the vehicle 100 and its components are specifically referenced for descriptive/illustrative purposes, it will be appreciated that the method 300 could be applicable to any suitably configured vehicle having an alternator and a suitable energy storage system. The method 300 begins at 304 where the control system 140 determines whether a set of one or more preconditions are satisfied. This could include, for example, the vehicle 100 having an ESS (e.g., ESS 132) that is capable of receiving high levels of charging current (e.g., a 12V Li-ion battery, a super/ultracapacitor, or some combination thereof). These precondition(s) could also include there being no malfunctions or faults present that would negatively impact or otherwise inhibit the alternator control techniques of the present application.

When the precondition(s) are not satisfied, the method 300 ends. When the precondition(s) are satisfied, the method 300 proceeds to 308. At 308, the control system 140 determines whether the alternator 104 is off. When true, the method 300 proceeds to 316. When false, the method 300 proceeds to 312. At 312, the control system 140 determines whether a torque addition (not a torque reduction) is requested. This could occur, for example, for a downshift operation of the transmission 120, for idle speed control, and/or replacing or supplementing spark retardation for catalyst light-off as previously described herein. When false, the method 300 proceeds to 316. When true, the method 300 proceeds to 352.

At 316, the control system 140 determines whether a torque reduction (not a torque addition) is requested. This could occur, for example, for an upshift operation of the transmission 120 and/or for idle speed control as previously discussed herein. When false, the control system 140 keeps the alternator 104 at its current operating conditions at 320 and the method 300 ends. When true, the method 300 proceeds to 324.

At 324, the control system 140 determines whether the ESS 132 can accept charge (e.g., a state of charge, or SOC, less than a maximum threshold, which could be approximately 80-90%). When false, the control system 140 keeps the alternator 104 at its current operating conditions at 328 and the method 300 ends. When true, the method 300 proceeds to 332. At 332, the control system 140 calculates a maximum torque reduction that can be provided by the alternator 104. This could correspond, for example, to a maximum duty cycle of the alternator 104.

At 336, the control system 140 determines whether the alternator 104 is capable of delivering the entire requested torque reduction. When true, the method 300 proceeds to 340 where the control system 140 turns the alternator 104 on at a desired level of torque reduction (e.g., a desired duty cycle less than or equal to the maximum duty cycle) and the control system 104 then sends the generated current from the alternator 104 to the ESS 132 for recharging at 344 and the method 300 ends.

When false, the method 300 proceeds to 348 where the control system 140 turns the alternator 104 on at its maximum duty cycle and completes the remainder of the requested torque reduction via other means (spark retardation, airflow control, etc.) and the control system 140 then sends the generated current from the alternator 104 to the ESS 132 for recharging at 344 and the method 300 ends. At 352, the control system 140 calculates the torque being consumed by the alternator 104 at its current duty cycle. At 356, the control system 140 determines whether the alternator is operating in a regenerative (regen mode) for recharging the ESS 132. When true, the control system 140 keeps the alternator 104 at its current operating conditions at 360 and the method 300 ends. When false, the control system 140 turns the alternator 104 off to drop the torque load on the torque generating system 112 at 364 so that the torque generating system 112 can better assist/provide torque delivery as requested (e.g., to complete the downshift operation of the transmission 120) and the method 300 then ends.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. An engine torque control system for a vehicle, the engine torque control system comprising:
an alternator driven by a crankshaft of an engine of the vehicle and configured to generate electrical energy;
an energy storage system configured to receive at least a maximum current from the alternator while the alternator is operating at a maximum duty cycle; and
a control system configured to:
detect a request to decrease a torque generated by the engine by a desired torque reduction; and
in response to detecting the request, command the alternator to operate at a desired duty cycle based on the desired torque reduction,
wherein the energy storage system receives and stores the electrical energy generated by the alternator while operating at the desired duty cycle.

2. The engine torque control system of claim 1, wherein the request corresponds to a shift request for a transmission arranged between the crankshaft of the engine and a driveline of the vehicle.

3. The engine torque control system of claim 2, wherein the shift request is for an upshift of the transmission.

4. The engine torque control system of claim 1, wherein the energy storage system is not a lead-acid or absorbent glass mat (AGM) battery.

5. The engine torque control system of claim 1, wherein the energy storage system is a lithium-ion battery.

6. The engine torque control system of claim 5, wherein the energy storage system includes at least one of the lithium-ion battery and at least one of a supercapacitor and an ultracapacitor.

7. The engine torque control system of claim 1, wherein the request corresponds to a request to replace or supplement spark retardation for catalyst light-off.

8. The engine torque control system of claim 1, wherein the request corresponds to a request to stabilize an idle speed of the engine.

9. The engine torque control system of claim 1, wherein the alternator is not a belt-driven starter-generator (BSG) unit having an electric motor.

10. The engine torque control system of claim 1, wherein the maximum current from the alternator while the alternator is operating at the maximum duty cycle is greater than 150 A.

11. An engine torque control method for a vehicle, the engine torque control method comprising:
providing an alternator driven by a crankshaft of an engine of the vehicle and configured to generate electrical energy;
providing an energy storage system configured to receive at least a maximum current from the alternator while the alternator is operating at a maximum duty cycle;
detecting, by a control system of the vehicle, a request to decrease a torque generated by the engine by a desired torque reduction; and
in response to detecting the request, commanding, by the control system, the alternator to operate at a desired duty cycle based on the desired torque reduction,
wherein the energy storage system receives and stores the electrical energy generated by the alternator while operating at the desired duty cycle.

12. The engine torque control method of claim 11, wherein the request corresponds to a shift request for a transmission arranged between the crankshaft of the engine and a driveline of the vehicle.

13. The engine torque control method of claim 12, wherein the shift request is for an upshift of the transmission.

14. The engine torque control method of claim 11, wherein the energy storage system is not a lead-acid or absorbent glass mat (AGM) battery.

15. The engine torque control method of claim 11, wherein the energy storage system is a lithium-ion battery.

16. The engine torque control method of claim 11, wherein the energy storage system includes at least one of the lithium-ion battery and at least one of a supercapacitor and an ultracapacitor.

17. The engine torque control method of claim 11, wherein the request corresponds to a request to replace or supplement spark retardation for catalyst light-off.

18. The engine torque control method of claim 11, wherein the request corresponds to a request to stabilize an idle speed of the engine.

19. The engine torque control method of claim 11, wherein the alternator is not a belt-driven starter-generator (BSG) unit having an electric motor.

20. The engine torque control method of claim 11, wherein the maximum current from the alternator while the alternator is operating at the maximum duty cycle is greater than 150 A.
